(19) United States
(12) Patent Application Publication
(10) Pub. No.: US 2016/0320286 A1
(43) Pub. Date: Nov. 3, 2016

(54) PARTICLE INSPECTION UNIT AND PARTICLE INSPECTION SYSTEM

(71) Applicant: KABUSHIKI KAISHA TOSHIBA, Tokyo (JP)

(72) Inventors: Hiroko MIKI, Kawasaki Kanagawa (JP); Michihiko NISHIGAKI, Kawasaki Kanagawa (JP); Kentaro KOBAYASHI, Tokyo (JP); Naofumi NAKAMURA, Tokyo (JP)

(73) Assignee: KABUSHIKI KAISHA TOSHIBA, Tokyo (JP)

(21) Appl. No.: 15/205,691

(22) Filed: Jul. 8, 2016

Related U.S. Application Data
(63) Continuation of application No. PCT/JP2014/071417, filed on Aug. 7, 2014.

(30) Foreign Application Priority Data
Feb. 26, 2014 (JP) 2014-035338

(51) Int. Cl. G01N 15/12; G01N 27/447; G01N 21/78

(52) U.S. Cl. CPC G01N 15/12; G01N 21/78; G01N 27/44791

(57) ABSTRACT

According to one embodiment, a particle inspection system includes an inspection module and a determination module. The inspection module includes a particle inspection chip includes electrodes for detecting existence of particles in a sample liquid by a change in an electrical signal, and a memory element which is provided separately from the electrodes and configured to store whether the inspection chip is a used chip or not. The determination module includes a determination circuit configured to determine the existence of the particles based on a detection signal of the inspection chip, and a control circuit configured to control an operation of the determination circuit from information in the memory element.

### CROSS REFERENCE TO RELATED APPLICATIONS

This application is a Continuation Application of PCT Application No. PCT/JP2014/071417, filed Aug. 7, 2014 and based upon and claiming the benefit of priority from Japanese Patent Application No. 2014-035338, filed Feb. 26, 2014, the entire contents of all of which are incorporated herein by reference.

### FIELD

Embodiments described herein relate generally to a particle inspection unit, a particle inspection system, and a particle inspection method for use in inspection of particles.

### BACKGROUND

Recently, in the technical fields of biotechnology, healthcare, and so on, micro-analysis chips having elements such as fine flow channels and detection mechanisms integrated thereon have been used. These micro-analysis chips often have tunnel flow channels formed by providing covers over fine grooves formed on glass substrates or resin substrates. As the detection mechanism, a product which uses particle detection by a micropore is known other than laser light scattering and fluorescent detection.

### BRIEF DESCRIPTION OF THE DRAWINGS

FIG. 1 is a block diagram briefly showing the configuration of a particle inspection system of a first embodiment;

FIG. 2 is a flowchart for describing a particle inspection method which uses the system of FIG. 1;

FIG. 3 is a block diagram briefly showing the configuration of a particle inspection system of a second embodiment;

FIG. 4 is a perspective view showing an entire structure of a particle inspection system of a third embodiment;

FIG. 5 is a plan view showing a structure of an inspection module used for the inspection system of FIG. 4;

FIG. 6 is a cross-sectional view taken along line I-I′ of FIG. 5;

FIG. 7 is a plan view briefly showing the structure of a first semiconductor micro-analysis chip;

FIG. 8 is a cross-sectional view taken along line A-A′ of FIG. 7;

FIG. 9 is a plan view briefly showing the structure of a second semiconductor micro-analysis chip;

FIG. 10 is a plan view briefly showing the structure of a third semiconductor micro-analysis chip;

FIG. 11 is a perspective view briefly showing the structure of the third semiconductor micro-analysis chip;

FIG. 12 is a plan view briefly showing the structure of a fourth semiconductor micro-analysis chip;

FIG. 13 is a perspective view briefly showing the structure of the fourth semiconductor micro-analysis chip;

FIG. 14 is a cross-sectional view conceptually showing the function of pillar arrays in the fourth semiconductor micro-analysis chip;

FIGS. 15A and 15B are illustrations showing an example of arrangement of the pillar arrays of the fourth semiconductor micro-analysis chip;

FIG. 16 is a perspective view briefly showing the structure of a fifth semiconductor micro-analysis chip;

FIG. 17 is a plan view briefly showing the structure of a sixth semiconductor micro-analysis chip;

FIG. 18 is a perspective view briefly showing the structure of the sixth semiconductor micro-analysis chip;

FIGS. 19A to 19C are cross-sectional views briefly showing the structure of the sixth semiconductor micro-analysis chip;

FIG. 20 is a plan view showing a modified example of the sixth semiconductor micro-analysis chip;

FIG. 21 is a perspective view showing the modified example of the sixth semiconductor micro-analysis chip;

FIGS. 22A to 22D are illustrations showing examples of arrangement of pillar arrays of the sixth semiconductor micro-analysis chip;

FIG. 23 is a cross-sectional view for describing a particle detection mechanism of the sixth semiconductor micro-analysis chip;

FIG. 24 is a perspective view briefly showing the structure of a seventh semiconductor micro-analysis chip;

FIG. 25 is a perspective view briefly showing the structure of an eighth semiconductor micro-analysis chip;

FIGS. 26A and 26B are cross-sectional views briefly showing the structure of the eighth semiconductor micro-analysis chip;

FIG. 27 is a perspective view briefly showing the structure of a ninth semiconductor micro-analysis chip;

FIG. 28 is a plan view briefly showing the structure of a tenth semiconductor micro-analysis chip;

FIG. 29 is a plan view briefly showing the structure of an eleventh semiconductor micro-analysis chip; and

FIG. 30 is a perspective view briefly showing the structure of the eleventh semiconductor micro-analysis chip.

### DETAILED DESCRIPTION

In general, according to one embodiment, a particle inspection system comprises an inspection module and a determination module. The inspection module comprises a particle inspection chip configured to detect existence of particles in a sample liquid by a change in an electrical signal, and a memory element configured to store whether the inspection chip is a used chip or not. The determination module includes a determination circuit configured to determine the existence of the particles based on a detection signal of the inspection chip, and a control circuit configured to control an operation of the determination circuit from information in the memory element. The inspection chip and the determination circuit are electrically connected to each other, and the memory element and the control circuit are electrically connected to each other.

When a micro-analysis chip for detecting existence of the particles which has been used once is used again, the chip will be under the influence of a previously-conducted inspection result. Therefore, measures against multiple use of the micro-analysis chip need to be taken.

Embodiments will be hereinafter described with reference to the accompanying drawings. Some specific materials and structures will be exemplified below.

However, materials and structures having the same function as those described may be employed similarly, and are not limited to those of the embodiments described below.

### First Embodiment

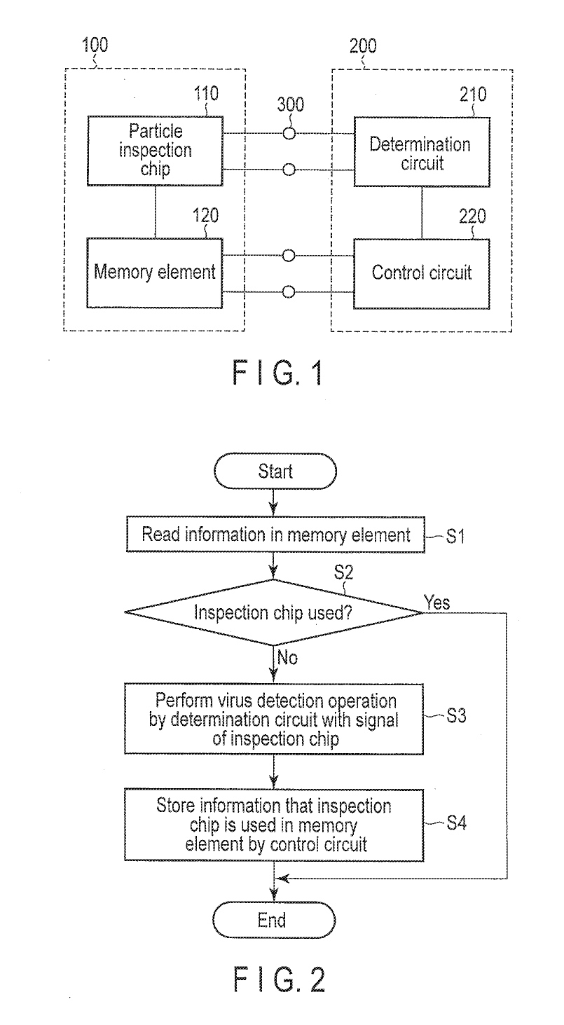

FIG. 1 is a block diagram briefly showing the configuration of a particle inspection system of a first embodiment.

An inspection module (a particle inspection unit) 100 is constituted of a particle inspection chip 110 configured to detect existence of particles such as viruses and bacteria in a sample liquid by a change in an electrical signal, and a memory element 120 configured to store whether the inspection chip 110 is a used chip or not. A determination module 200 is constituted of a determination circuit 210 configured to determine the existence of the particles based on a detection signal of the inspection chip 110, and a control circuit 220 configured to control the operation of the determination circuit 210 from information in the memory element 120.

The inspection module 100 and the determination module 200 are configured to be mechanically detachable, and they are electrically connected via a detachable electrical contact 300. Further, by mounting the inspection module 100 on the determination module 200, the inspection chip 110 is electrically connected to the determination circuit 210, and the memory element 120 is electrically connected to the control circuit 220. Note that the electrical contact 300 is not necessarily required, and the system may be structured in any way any as long as the necessary portions are electrically connected to each other when the inspection module 100 is mounted on the determination module 200.

The inspection chip 110 comprises a flow channel provided to allow a sample liquid to flow over a surface portion of a semiconductor substrate, a micropore arranged at a part of the flow channel to allow particles in the sample liquid to pass therethrough, and detection electrodes with the micropore sandwiched between the electrodes. A voltage is applied between the electrodes, thereby detecting the particles from a change in a current when the particles in the sample liquid pass through the micropore. The specific structure of such a semiconductor micro-analysis chip will be described below.

The memory element 120 is a fuse which is blown by electrical conduction when inspection is conducted by the inspection chip 110, and is provided, for example, on a part of the semiconductor substrate which constitutes the inspection chip 110. Note that the memory element 120 is not limited to a fuse, and may be any as long as it can store a usage state of the inspection chip 110. As the memory element 120, a semiconductor memory (RAM, flash RAM), for example, may be used. Also, the memory element 120 does not need to be formed directly on the inspection chip 110 in all cases. Alternatively, the memory element 120 can be formed on the substrate on which the inspection chip 110 is mounted.

The determination circuit 210 applies a voltage between the electrodes provided near the micropore of the inspection chip 110, and determines existence or nonexistence of the particles from a change in the current when the particles pass through the micropore. The control circuit 220 operates the determination circuit 210 if the inspection chip 110 is unused from the information in the memory element 120, and further operates the memory element 120 to store the information that the inspection chip 110 is a used chip after determination has been made by the determination circuit 210. If the memory element 120 is a fuse, the control circuit 220 blows the fuse by the electrical conduction.

Next, an inspection method using the particle inspection system structured as indicated above will be described with reference to the flowchart of FIG. 2.

Firstly, after a sample liquid has been poured into the particle inspection chip 110, the inspection module 100 is mounted on the determination module 200 to connect the two mechanically and electrically. Further, by the control circuit 220, information in the memory element 120 is read (step S1). If the memory element 120 is a fuse, a voltage is applied to the memory element 120 from the control circuit 220, and the control circuit 220 reads whether a current flows. Note that the voltage at this time is extremely low, and the current at this time is extremely small. If the inspection chip 110 is unused, the fuse is not blown, and vice versa, if the inspection chip 110 is used, the fuse is blown. Therefore, whether or not the inspection chip 110 has been used can be detected by checking whether a current flows or not (step S2).

If it is detected that the inspection chip 110 is a used chip, the processing is to be terminated without conducting the inspection. In this way, it is possible to prevent the used inspection chip 110 from being used again for the particle inspection.

If it is detected that the inspection chip 110 is unused, inspection of the particles is carried out by the determination circuit 210 based on the detection signal of the inspection chip 110 (step S3). That is, a voltage is applied between the detection electrodes of the inspection chip 110 from the determination circuit 210, and an operation of detecting the existence or nonexistence of the particles is carried out on the basis of a change in the current flowing between these electrodes.

When the operation of detecting the particles by the determination circuit 210 ends, the control circuit 220 causes the memory element 120 to store the information that the inspection chip 110 is a used chip in the memory element 120 (step S4). If the memory element 120 is a fuse, a large current is passed to the memory element 120 from the control circuit 220 to blow out the fuse.

In this way, the operation of detecting the particles can be performed by the determination circuit 210 only when the inspection chip 110 is unused. Moreover, when the inspection chip 110 is used, the information that the chip has been used can be written in the memory element 120 of the inspection module 100 by blowing out the fuse of the memory element 120 by the control circuit 220. Thus, the used inspection chip 110 will not be reused for inspection.

As can be seen, according to the present embodiment, whether the inspection chip 110 is a used chip or not can be read from the information in the memory element 120, and inspection by the determination circuit 210 can be stopped if the chip is used. Thus, erroneous determination caused by the particles that remain in the inspection chip 110 can be prevented. That is, it is possible to prevent erroneous determination that a positive reaction is shown even though the result should have been indicated as negative caused by reusing the used inspection chip showing a positive reaction. Also, by conducting the inspection of particles by using the flow channel and the micropore provided on the semiconductor substrate, highly-sensitive particle inspection can be carried out.

That is, it is possible to detect the particles in the sample liquid, prevent erroneous determination caused by using the inspection chip more than once, and improve reliability of the inspection. Further, using the semiconductor micro-analysis chip that will be described later as the particle inspection chip 110 enables to achieve miniaturization and mass production of the system, and also to bring about an advantage of constructing the system at low cost.

### Second Embodiment

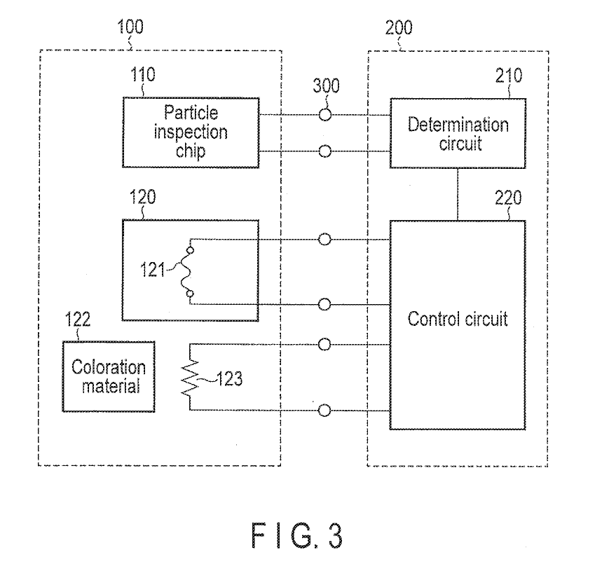

FIG. 3 is a block diagram briefly showing the configuration of a particle inspection system of a second embodiment. Note that structural elements identical to those in FIG. 1 will be denoted by the same reference numbers as in FIG. 1, and detailed explanations of them will be omitted.

The present embodiment differs from the first embodiment described above in that a coloration material 122 which can be visually checked by the user is used, in addition to using a fuse 121 which gives a change in electrical information as a memory element 120.

In an inspection module 100, the coloration material 122 which changes its color by heat is provided on an upper surface of a semiconductor substrate which constitutes an inspection chip, an upper surface of a semiconductor substrate having an inspection chip mounted thereon, or a surface of a case which accommodates a substrate. Further, a heater 123 which generates heat by electrical conduction from a control circuit 220 is provided in the proximity of the coloration material 122. As the coloration material 122, a heat label, a heat-sensitive label, or WAX thermo ink, etc., which changes its color when a temperature is increased, may be used.

In a state where an inspection chip 110 has never been used, the fuse 121 of the memory element 120 is not blown, and the coloration material 122 shows its original color. When a sample liquid is poured into the inspection chip 110 and inspection of particles is conducted by mounting the inspection module 100 on a determination module 200, the inspection is carried out as in the first embodiment described above. When the inspection is finished, the fuse 121 is blown as in the first embodiment. Concurrently with this, electricity is conducted to the heater 123 from the control circuit 220. Consequently, the coloration material 122 is heated and the color of the coloration material 122 changes.

As described above, once the inspection chip 110 is used, the color of the coloration material 122 is changed as well as the blow of the fuse 121. Accordingly, not only can the use of the inspection chip 110 be detected from the blow of the fuse 121 which is caused by the control circuit 220, but the user can also confirm whether the inspection chip 110 is a used chip from the change of color of the coloration material 122.

As can be seen, according to the present embodiment, not only can the advantage similar to that of the first embodiment be obtained, but also the use of the inspection chip 110 can be simply determined by visually checking the coloration material 122 of the inspection module 100. Accordingly, whether or not the inspection chip 110 is used can be checked by the inspection module 100 separately before it is connected to the determination module 200, and the sample liquid can be prevented from being wasted on the used inspection chip 110.

Instead of the coloration material 122, metal which changes its form by electrical conduction, for example, a material which is bent when electricity is conducted (an element composed by combining an electroactive polymer, an acrylic board, a silicon element, etc.) may be used.

### Third Embodiment

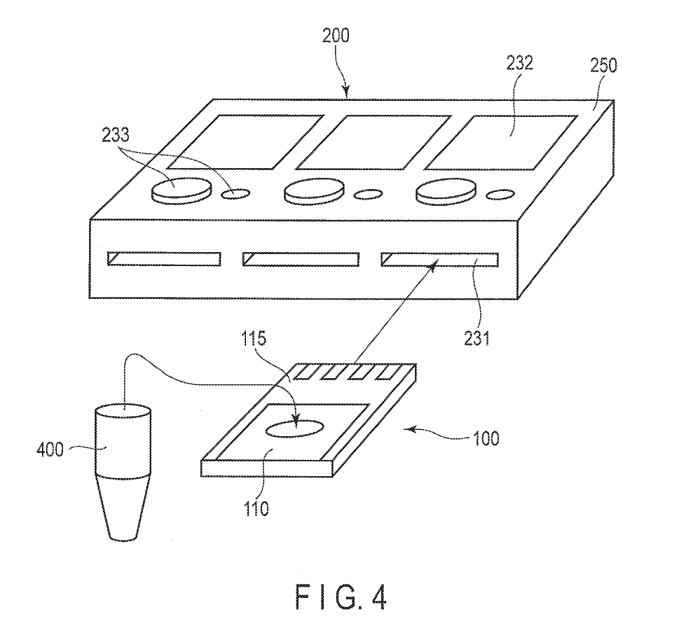

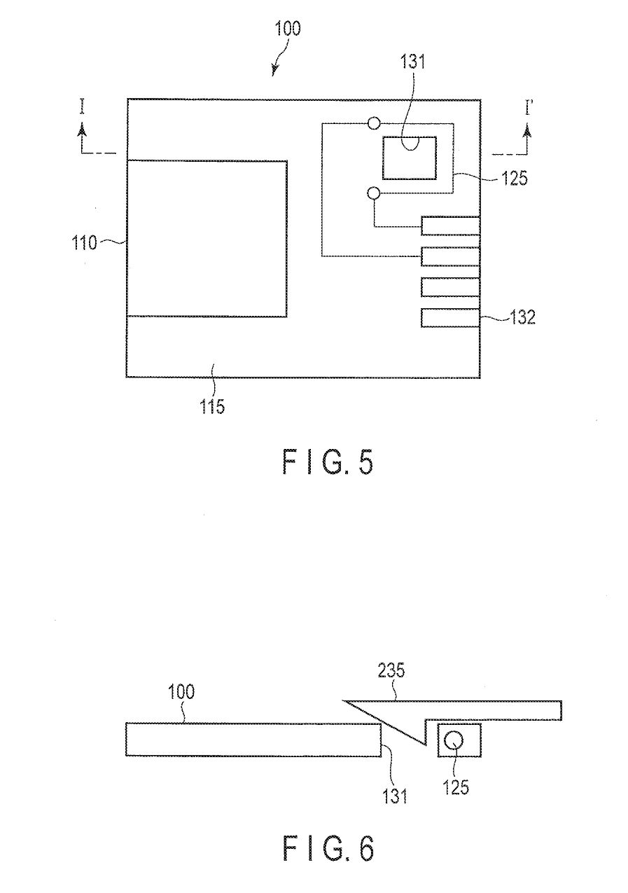

FIG. 4 is a perspective view showing the entire structure a particle inspection system of a third embodiment. FIG. 5 is a plan view showing the structure of an inspection module, and FIG. 6 is a cross-sectional view taken along line I-I′ of FIG. 5.

As shown in FIG. 4, on a side surface of a housing 250 which accommodates a determination module 200, a slit 231 into which an inspection module 100 can be inserted is provided. Further, on a top surface of the housing 250, a display 232 configured to display an inspection result of an inspection chip 110, press-button switches 233 for various operations, etc., are provided. The embodiment of FIG. 4 is provided with three slits 231 to allow three inspection modules 100 to be mounted therein, respectively, for improving working efficiency. However, the housing 250 may be designed to allow one inspection module 100 to be mounted therein of course.

The inspection module 100 includes a substrate 115 on which the inspection chip 110 is mounted, and the substrate 115 can be inserted into the slit 231 of the housing 250. Note that reference number 400 indicates a container which contains a sample liquid, and the sample liquid is to be poured into the inspection chip 110 from the container 400.

As shown in FIG. 5, the substrate 115 of the inspection module 100 is provided with a cavity 131 and a connection terminal 132. The cavity 131 is provided near a corner part of the substrate 115. Since the cavity 131 is provided near the corner part of the substrate 115, a narrow area of the substrate 115 is produced near the cavity 131. An interconnect 125 as a memory element 120 is arranged in such a way that it passes the narrow area near the cavity 131. The connection terminal 132 is arranged on one side of the substrate 115 to connect with the determination module 200. The connection terminal 132 is partially connected to electrodes of the inspection chip 110, and partially to the interconnect 125.

As shown in FIG. 6, when the inspection module 100 is mounted in the determination module 200, a projection 235 provided at a cassette insertion opening of the housing 250 of the determination module 200 is configured to be fitted into the cavity 131 of the substrate 115 of the inspection module 100. When the inspection module 100 is drawn out of the housing 250 upon completion of the inspection, the narrow area of the substrate 115 is broken, and the interconnect 125 is thereby cut off.

With such a structure, a disconnection state of the interconnect 125 can be detected by a control circuit 220 of the determination module 200 by mounting the inspection module 100 in the housing of the determination module 200. This is similar to the case in which a fuse is used as the memory element 120. Accordingly, whether the inspection chip 110 is unused or not can be known, and the inspection can be conducted only when the inspection chip 110 is unused as in the embodiments described above.

When the inspection is completed and the inspection module 100 is drawn out of the housing 250, because the projection 235 is fitted into the cavity 131 provided on the substrate 115 of the inspection module 100, the narrow area near the cavity 131 is broken. Because of this, the interconnect 125 arranged in the narrow area is broken. In this way, the fact that the inspection chip 110 is a used chip can be stored in the inspection module 100.

As can be seen, according to the present embodiment, a usage state of the inspection chip 110 can be stored by a mechanical operation of drawing the inspection module 100 out of the housing 250 of the determination module 200. That is, the memory element 120 can be formed by an ordinary interconnect without using a member which is disconnected by electrical conduction, such as a fuse. Accordingly, not only can the advantage similar to that of the above first embodiment be obtained, but also the present embodiment has an advantage of being able to realize the particle inspection system at low cost because a power source, etc., for blowing the fuse does not need to be provided in the control circuit 220.

(Examples of Particle Inspection Chip)

Examples of the semiconductor micro-analysis chip used for the inspection chip 110 of each of the above embodiments will now be described.

[First Semiconductor Micro-Analysis Chip]

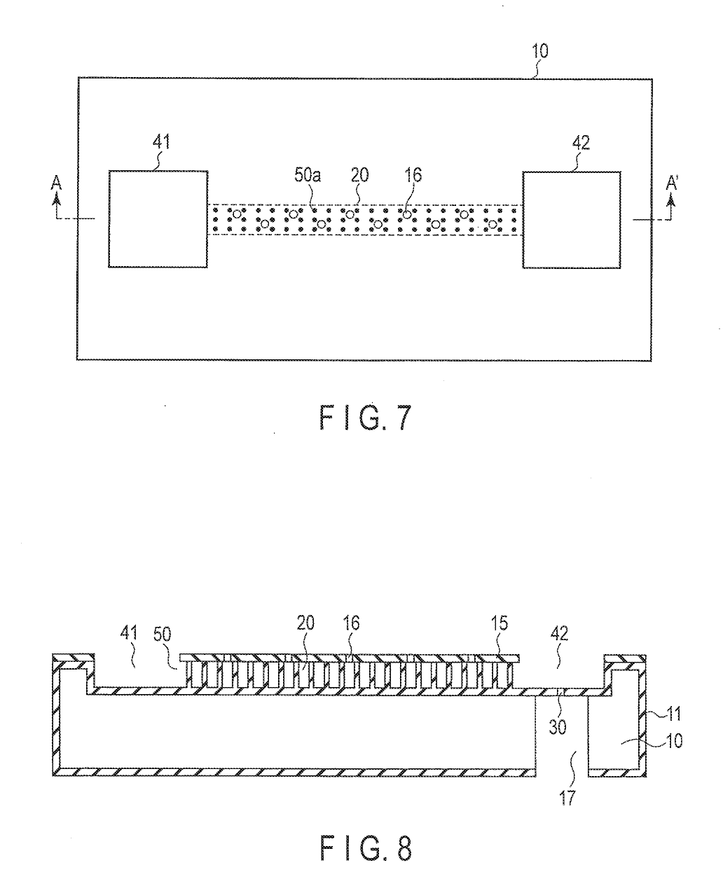

FIGS. 7 and 8 are figures for describing a brief structure of a first semiconductor micro-analysis chip. FIG. 7 is a plan view, and FIG. 8 is a cross-sectional view taken along line A-A′ of FIG. 7.

In the figures, reference number 10 denotes a semiconductor substrate. Various semiconductor materials, such as Si, Ge, SiC, GaAs, InP, and GaN, may be used for the substrate 10. In the following, an example in which Si is used for the semiconductor substrate 10 will be described.

On a surface portion of the Si substrate 10, a flow channel 20 formed of a linear groove is formed. The flow channel 20 is a channel in which a sample liquid including fine particles to be detected is made to flow, and is formed by etching a surface of the Si substrate 10 by, for example, 50 μm in width and 2 μm in depth. On both ends of the flow channel 20, an opening portion 41 and an opening portion 42 for introducing and discharging the sample liquid are provided, and electrodes can be inserted into the opening portions 41 and 42, respectively. At an area excluding the both ends of the flow channel 20, a pillar array 50 is provided. The pillar array 50 is constituted by columnar structures (pillars) 50a extending from the bottom of the flow channel 20 to the surface of the Si substrate 10, which are arranged at regular intervals, as an array. A diameter of the pillar 50a is, for example, 1 μm, and a gap between adjacent pillars is, for example, 0.5 μm.

Here, the bottom of the flow channel 20 is covered by an SiO₂ film 11, and the pillar array 50 is also formed of SiO₂. Further, an upper portion of the flow channel 20 is covered by a cap layer 15 formed of SiO₂. Ashing holes 16 for speedily removing a sacrifice layer for flow channel formation are formed at several places of the cap layer 15.

In the opening portion 42, a back opening 17 is provided at the back side of the flow channel 20, and a micropore 30 is provided at the bottom of the flow channel 20. The flow channel 20 and the back opening 17 of the Si substrate 10 are spatially connected to each other via the micropore 30.

In the first semiconductor micro-analysis chip, when a sample liquid is poured into an introduction opening 41, that is, an inlet, the sample liquid flows through the flow channel 20 and reaches a discharge opening 42, that is, an outlet by the capillary action. The back opening 17 is filled with an electrically conductive liquid which does not contain a particulate sample. Then, electrodes (metal wires, etc.) for measuring the passing current of the micropore 30 are inserted into the outlet 42 and the back opening 17, respectively, and a voltage is applied from the determination circuit 210 of the determination module 200. Further, an ion current that flows between the electrodes is observed. When a particle passes through the micropore 30, the particle occupies a part of the micropore 30, and thus the electrical resistance of the portion of the micropore 30 changes. The ion current is changed in accordance with the change in the electrical resistance. As described above, a particle which has passed through the micropore 30 can be detected by observing, by the determination circuit 210, the change in the ion current when the particle passes through the micropore 30.

The semiconductor micro-analysis chip as described above is made of a semiconductor wafer such as Si, and mass production technology with semiconductor fabrication process technology can be utilized. For this reason, the semiconductor micro-analysis chip can be minizaturized to a considerable degree and be manufactured in large quantities in comparison with a micro-analysis chip using a quartz substrate or a resin substrate that is often adopted in the prior art. Thus, a large number of semiconductor micro-analysis chips can be manufactured at low cost.

Further, the semiconductor micro-analysis chip does not require bonding process of bonding another substrate or a cover glass to form a sealing structure (lid) of the flow channel, and the cost of the bonding process can be cut down. Further, since the particles are to be detected electrically, noise separation from detection signals by utilizing electronic circuit technology, and highly-sensitive detection with real-time digital processing (statistical processing, etc.) can be achieved. Moreover, a detection system can be made drastically compact in comparison with an optical detection system because the micro-analysis chip does not require equipment such as an optical system which occupies much space.

Also, a plurality of holes are provided in the small flow channel, and these holes are used as the ashing holes for removing the sacrifice layer formed for forming the flow channel. The time required for removing the sacrifice layer can be thereby reduced drastically, and the manufacturing cost can be reduced.

Moreover, when a semiconductor memory is used as the memory element 120, since the basic material of the semiconductor micro-analysis chip is a semiconductor substrate, there is an advantage that the semiconductor memory can be directly manufactured on the semiconductor substrate.

[Second Semiconductor Micro-Analysis Chip]

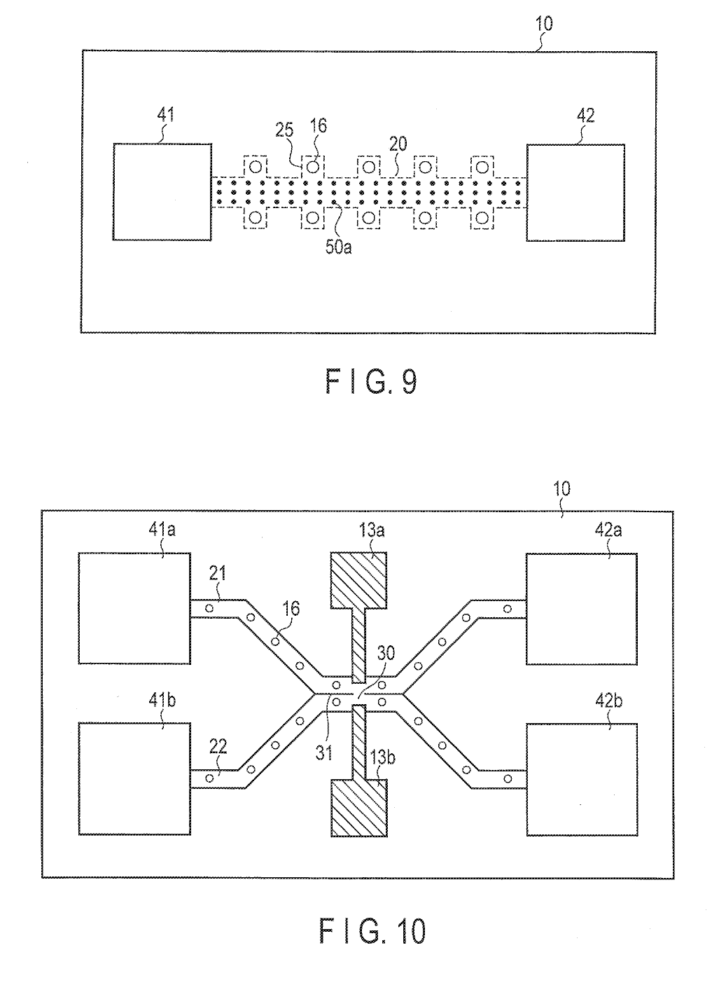

FIG. 9 is a plan view showing a brief structure of a second semiconductor micro-analysis chip. Note that structural elements identical to those in FIG. 7 will be denoted by the same reference numbers as in FIG. 7, and detailed explanations of them will be omitted.

The point in which the second semiconductor micro-analysis chip is different from the first semiconductor micro-analysis chip is that a channel portion 25 which communicates with a flow channel 20 is provided on a side part of the flow channel 20, and an ashing hole 16 is formed in a cap layer 15 above the channel portion 25. For example, on both side surfaces of the flow channel 20, channels portions 25 which are slightly larger than ashing holes to be formed are arranged at regular intervals, and the ashing holes 16 are formed in the channel portions 25, respectively.

Even in this structure, because the ashing holes 16 are provided, removal of a sacrifice layer in forming the flow channel 20 can be conducted speedily as in the first semiconductor micro-analysis chip. Further, the ashing holes 16 can be used as air holes for passing a sample liquid. Furthermore, holes are not directly formed in the flow channel 20, but the holes 16 are formed in the channel portions 25 provided at side walls of the flow channel. Accordingly, the semiconductor micro-analysis chip has an advantage of being able to form the holes 16 without decreasing the strength of a flow channel ceiling.

[Third Semiconductor Micro-Analysis Chip]

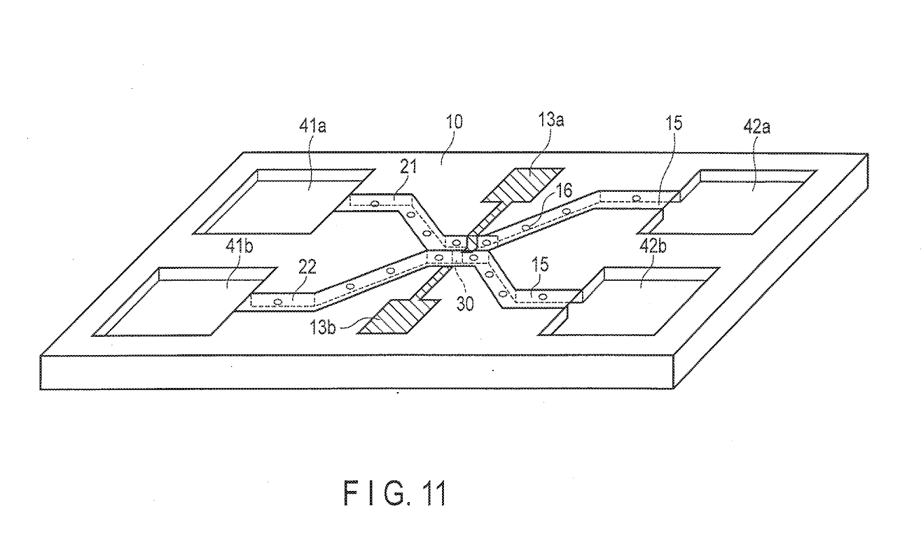

FIG. 10 is a plan view for schematically illustrating a third semiconductor micro-analysis chip, and FIG. 11 is a perspective view for explaining a brief structure of the third semiconductor micro-analysis chip.

In the figures, reference number 10 denotes a semiconductor substrate. Various semiconductor materials, such as Si, Ge, SiC, GaAs, InP, and GaN, may be used for the substrate 10. In the following, an example in which Si is used for the semiconductor substrate 10 will be described.

Reference number 21 denotes a first flow channel in which a sample liquid flows, and 22 denotes a second flow channel in which the sample liquid or an electrolyte flows. The flow channels 21 and 22 are arranged to be partially close to each other in different layouts, and are formed by, for example, etching the Si substrate 10 to a width of 50 μm and a depth of 2 μm. Further, an upper portion of each of the flow channels 21 and 22 is covered with an insulating thin film (having a thickness of, for example, 200 nm) such as a silicon oxide (SiO₂) film, a silicon nitride (SiNₓ) film, or an alumina (Al₂O₃) film. As shown in FIG. 11, flow channel caps (i.e., lids to seal the flow channels 21 and 22) as cap layers 15 are formed on the upper portions of the flow channels 21 and 22. Both the first and the second flow channels are thereby formed as groove-shaped tunnel flow channels. Further, in the cap layers 15, ashing holes 16 to be used when removing a sacrifice layer are formed.

Reference numbers 41a and 42a denote an inlet and an outlet of the sample liquid located at the ends of the first flow channel 21, respectively. Reference numbers 41b and 42b denote an inlet and an outlet of the sample liquid or the electrolyte located at the ends of the second flow channel 22, respectively. The inlets and outlets denoted as 41a, 41b, 42a, and 42b are formed by etching a surface portion of the Si substrate 10 into a shape of a i-mm-sided square, for example, with a depth of 2 μm, for example. The cap layers 15 are formed in the range of the flow channels 21 and 22, and no cap layer is formed in the inlets and outlets 41a, 41b, 42a, and 42b. The flow channels 21 and 22 are thereby formed as tunnel-like flow channels opening at their inlets and outlets.

Reference number 30 denotes a micropore provided at a contact portion between the first flow channel 21 and the second flow channel 22. The micropore 30 is formed by partial etching of a partition 31 (for example, an SiO₂ wall with a thickness of 0.2 μm) between the flow channel 21 and the flow channel 22 in a slit shape. The size (width) of the micropore 30 is not limited as long as it is slightly greater than the size of particles to be detected. When the size of the particles to be detected is 1 μm in diameter, the width of the micropore 30 of FIG. 10, may be, for example, 1.5 μm.

Reference numbers 13a and 13b denote electrodes configured to detect the particles. The electrodes 13a and 13b are formed to be partially exposed inside the flow channels 21 and 22, respectively. As the materials of the electrodes 13a and 13b, AgCl, Pt, Au, etc., may be used in the portion of surfaces where the electrodes are in contact with the sample liquid. The electrodes 13a and 13b do not necessarily have to be integrated as shown in FIG. 11. That is, even if the electrodes 13a and 13b are not integrated, the particles can be detected by attaching external electrodes to the inlets and outlets of the flow channels, respectively.

An ion current flowing through the micropore 30 is basically determined on the basis of the aperture size of the micropore 30. In other words, a current (a steady current when the particles do not pass through the flow channels) caused to flow by applying a voltage to the electrodes 13a and 13b in the flow channels 21 and 22, which are filled with the electrolytes (solutions obtained by dissolving an electrolyte which allow passage of ion currents), respectively, is determined on the basis of the aperture size of the micropore 30.

When a particle to be detected passes through the micropore 30, the particle partially blocks the passage of ions through the micropore 30, causing the ion current reduction in accordance with the degree of blockage. However, if the particle is conductive or can become conductive at a surface level, an ion current increase corresponding to the particle passage through the micropore 30 is observed because of electrical conduction of the particle itself caused by giving and receiving of ion charges. Such ion current variation is determined on the basis of the relative relationships in shape, size, length, etc., between the micropore 30 and the particles. For this reason, a feature of the particles passing through the micropore can be recognized by observing the amount of variation, transient variation, etc., of the ion current.

The aperture size of the micropore 30 may be determined by considering ease of passage of the particles to be detected and variation degree (sensitivity) of the ion current. For example, the aperture size of the micropore 30 may be 1.5 times to 5 times as great as the outside diameter of the particles to be detected. As the electrolyte to disperse the particles to be detected, a KCl solution or various buffer solutions such as a Tris Ethylene diamine tetra acetic acid (TE) buffer solution and a phosphate buffered saline (PBS) may be used.

In the third semiconductor micro-analysis chip shown in FIGS. 10 and 11, for example, the first flow channel 21 is used as a sample liquid introduction flow channel, and the sample liquid (i.e., a suspension liquid obtained by dispersing fine particles to be detected in an electrolyte) is dropped to the inlet 41a. At this time, since the flow channel 21 is the tunnel-like flow channel as described above, as soon as the sample liquid reaches the entrance of the flow channel 21, the sample liquid is drawn into the flow channel 21 by the capillary action, and then the interior of the flow channel 21 is filled with the sample liquid. Here, the ashing holes 16 serve as air holes, and the filling of the sample liquid can be carried out smoothly.

The second flow channel 22 is used as a flow channel for receiving the detected particles. An electrolyte which does not include the particles to be detected is dropped into the inlet 41b, and then the interior of the inlet 41b is filled with the electrolyte. In the above state, by applying a voltage between the electrode 13a and the electrode 13b from the determination circuit 210, particles passing through the micropore 30 can be detected.

A polarity of the voltage applied between the electrodes 13a and 13b varies depending on the charge of the particles (bacteria, viruses, labeled particles, etc.) to be detected. For example, to detect negatively-charged particles, a negative voltage is applied to the electrode 13a, and a positive voltage to the electrode 13b. In this configuration, the particles are electrophoresed by the electric field in the solution, and then the ion current variation is observed according to above-mentioned mechanism.

The second flow channel 22 as well as the first flow channel 21 can be filled with the sample liquid. This condition can be employed particularly when the charge of the particles to be detected is unclear or when positively-charged particles and negatively-charged particles are mixed. Even when the charge of the particles to be detected is known, the detection may be executed by filling both the flow channels with the sample liquid. In this case, because two types of solutions, i.e., the sample liquid and the electrolyte, do not need to be prepared, an operation relevant to detection of the particles can be simplified. However, the inlets 41a and 41b (outlets 42a and 42b) of the flow channels need to be electrically separated from each other, i.e., the sample liquid in one of the inlets (outlets) needs to be separated from that in the other one.

Thus, in the third semiconductor micro-analysis chip, the particles can be detected only by the sample liquid introduction and the electrical observation. Further, the ultraminiaturization and mass production can be implemented by the semiconductor processing technique, and a particle detection circuit, a particle discrimination circuit, etc., can also be integrated. Accordingly, ultraminiaturized and highly-sensitive semiconductor micro-analysis chips can be manufactured in large quantities and at low cost.

Therefore, highly-sensitive detection of bacteria, viruses, etc., can be easily conducted. The semiconductor micro-analysis chip as described can contribute to preventing epidemic diseases from spreading and maintaining food safety, by applying the semiconductor micro-analysis chip to a rapid test of infectious pathogens, food-poisoning-causing bacteria, etc. The semiconductor micro-analysis chips as described are suitable for use in situations where a large number of chips need to be provided at very low cost. For example, they may be suitably used as high-speed primary test kits for diseases which require emergency quarantine action such as new strains of influenza, simple home-administered food-poisoning tests, and the like.

[Fourth Semiconductor Micro-Analysis Chip]

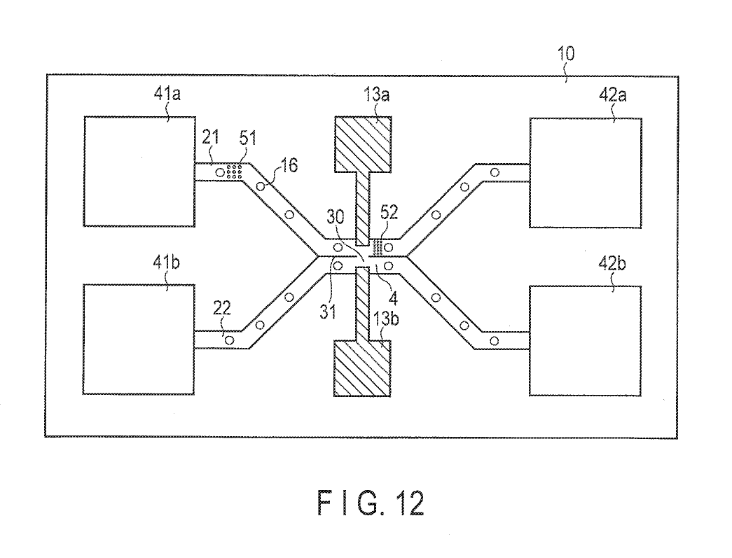

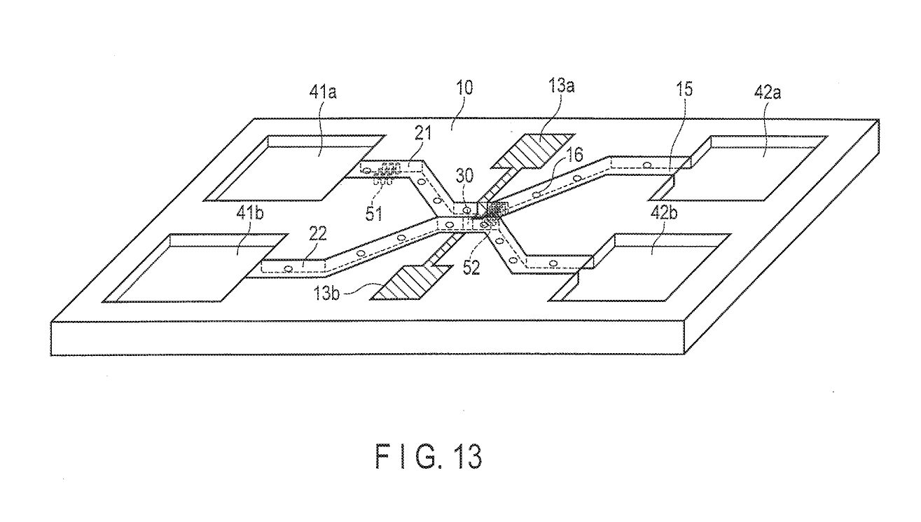

FIGS. 12 and 13 illustrate a brief structure of a fourth semiconductor micro-analysis chip. FIG. 12 is a plan view of the semiconductor micro-analysis chip, and FIG. 13 is a perspective view of the same. In the semiconductor micro-analysis chip, a particle size filter is provided in a sample liquid flow channel 21.

In FIGS. 12 and 13, reference numbers 51 and 52 denote micro-size pillar arrays composed of micro-columnar structures (pillars) arranged at regular intervals to filter the particles in a sample liquid by size based on the intervals. Wall-like structure (slit) arrays, etc., can also be used instead of the pillar arrays 51 and 52. A structure and a function of the particle filter will be described taking the case of introducing the sample liquid to an inlet 41a and guiding the sample liquid to the flow channel 21 as an example.

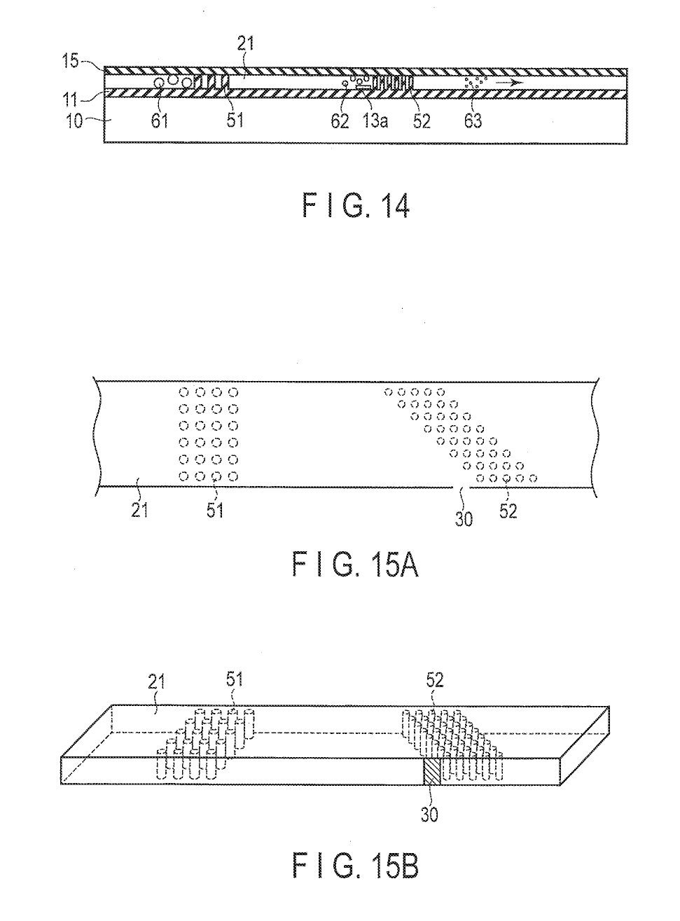

FIG. 14 schematically illustrates the function of the pillar arrays 51 and 52. The first pillar array 51 is provided at an upstream side of a micropore 30, and serves as a filter configured to remove large particles 61 which would clog the micropore 30. The pillar array 51 is formed such that pillars are provided at intervals which allow particles-to-be-detected 62 to pass through the pillar array 51 but do not allow the particles 61 having a diameter larger than the aperture of the micropore 30 to pass through. For example, if the diameter of the particle to be detected is 1 μm, and the diameter of the micropore is 1.5 μm, the pillars of the pillar array 51 are arranged in a manner described below. That is, as the pillar array 51, columnar structures having a diameter of 2 μm or quadrangular prism-shaped structures having a length of 2 μm on a side are formed so as to have an interval of, for example, 1.3 μm at maximum in a transverse direction of the flow channel. The number of steps (i.e., the number of rows) of the pillars of the pillar array 51 may be determined in consideration of trap efficiency of the large particles 61. Substantially all the particles having an outer diameter of 1.3 μm or more can be trapped when the pillar array 51 is arranged in the transverse direction of the flow channel with, for example, ten steps (ten rows) of pillars.

In addition, a multi-stepped filter structure can be provided such that a pillar array (not shown) having greater intervals of pillars is provided in the upstream of the pillar array 51 to preliminarily filter the particles having a diameter of, for example, 5 μm or more before the pillar array 51. In this case, it becomes easy to prevent the particle filter (pillar array 51) itself from being clogged by the large particles 61. For this reason, pretreatments such as centrifugation and preprocessing filtration of the sample liquid can be omitted, and thus the work for detecting the particles can be simplified and accelerated.

In FIG. 14, the pillar array 52 serves as a collector configured to collect and concentrate the particles-to-be-detected 62. The pillar array 52 is provided at a downstream side of the micropore 30, and pillars of the pillar array 52 are formed at intervals which do not allow the particles-to-be-detected 62 to pass through, but allow the electrolyte and microparticles 63 that are out of the scope of detection to pass through. For example, if the diameter of the particles to be detected is 1 μm, as the pillar array 52, columnar structures having a diameter of 1 μm or quadrangular prism-shaped structures having a length of 1 μm on a side are formed so as to have an interval of, for example, 0.9 μm at maximum in the transverse direction of the flow channel. The number of steps (i.e., the number of rows) of the pillars of the pillar array 52 may be determined in consideration of trap efficiency of the particles-to-be detected 62. Substantially all the particles having an outer diameter of 1.0 μm or more can be trapped by providing the pillar array 52 in the transverse direction of the flow channel 21 with, for example, ten steps (ten rows) of pillars.

In addition, as shown in FIGS. 15A and 15B, pillars of the pillar array 52 may be arranged so as to obliquely cross the flow channel 21, with the micropore 30 positioned close to a portion located at the most downstream side of the upstream side ends of the pillars. Since the trapped particles are guided to the portion of the micropore 30 efficiently, the detection efficiency can be enhanced.

Only one of the pillar arrays 51 and 52 may be provided instead of providing both of the pillar arrays. The number of the pillar arrays to be provided can be determined in consideration of the features of the sample liquid to be applied, process of the detection steps, etc. In addition to the pillar arrays 51 and 52 which serve as the particle size filters, pillar arrays with intervals greater than the intervals of the pillar arrays 51 and 52 may be formed all over the flow channel. In this case, each of the pillars can function as a supporting column of the cap of the flow channel, and can prevent the flow channel cap from being collapsed by an external pressure or a surface tension of the sample liquid. Moreover, the surface tension of the electrolyte can also act between the pillars to work as a driving force to draw the electrolyte, thereby enabling the flow channel to be filled with the sample liquid and the electrolyte more easily.

Pillar arrays may also be formed at intervals greater than the pillar intervals which can be the particle size filter, in the regions of the sample liquid inlets 41a and 41b and the sample liquid outlets 42a and 42b with the flow channel cap not provided. With the above configuration, the sample liquid and the electrolyte dropped onto the inlets can be spread by the surface tension of the pillar arrays, and the solutions can smoothly flow into the flow channels.

As can be seen, in the fourth semiconductor micro-analysis chip, the particle size filtering function can be added by arranging the pillar arrays (or slit arrays) in the sample liquid inlet flow channel.

Further, the detection steps can be simplified and the accuracy in detecting the particles can be enhanced by adding the functions of removing unnecessary particles, concentrating the particles to be detected, etc. Therefore, not only the advantage similar to the advantage of the third semiconductor micro-analysis chip can be obtained, but the present semiconductor micro-analysis chip also has the advantage that the detection time can be reduced and the detection errors can be reduced and prevented.

[Fifth Semiconductor Micro-Analysis Chip]

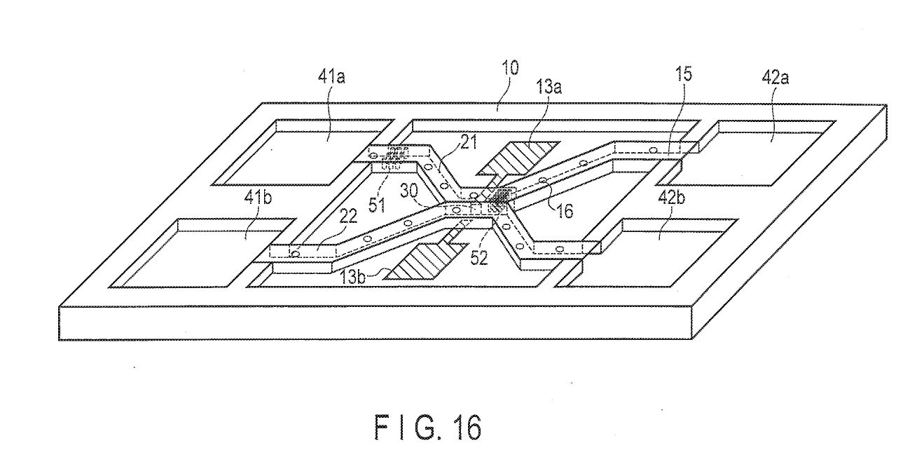

FIG. 16 is a perspective view showing a brief structure of a fifth semiconductor micro-analysis chip. In this chip, flow channels 21 and 22 are not constituted by grooves of an Si substrate 10, but covered with tunnel-like insulating films. That is, instead of using engraved grooves of the Si substrate 10 as the flow channels, insulating film tunnel type flow channels, which are made by forming a sacrifice layer in a flow channel pattern, and then covering an upper surface and side surfaces of the sacrifice layer by an insulating film, are used.

Since the present semiconductor micro-analysis chip does not involve etch-back process or CMP process of the sacrifice layer, in-plane unevenness such as residues of the sacrifice layer and reduction of film thickness hardly occurs. Hence, process failure in the sacrifice layer formation steps is considerably reduced. Accordingly, not only the advantage similar to that of the third semiconductor micro-analysis chip can be obtained, a manufacturing yield can also be improved. Further, by virtue of ashing holes 16, the time required for the ashing process can be reduced and equalized. In addition, a gap between a thermally-oxidized film 11 and a cap layer 15 which would be caused by the residues of the sacrifice layer is essentially hard to be created. For this reason, a problem of leakage failure of an ion current is also substantially resolved.

The inlets and outlets (41a, 41b, 42a, and 42b) of the present inspection chip can be basically formed similarly to those shown in FIGS. 11 and 13, but liquid dams of the reservoirs need to be formed at portions of connection between the flow channels of the insulating film tunnel type and the reservoirs. For this reason, Si terraces may be formed beside the openings at the ends of the flow channels 21 and 22, as shown in FIG. 16, or dummy flow channels may be formed at up to the Si terrace portions beside the openings at the ends of the flow channels, and used as the liquid dams.

[Sixth Semiconductor Micro-Analysis Chip]

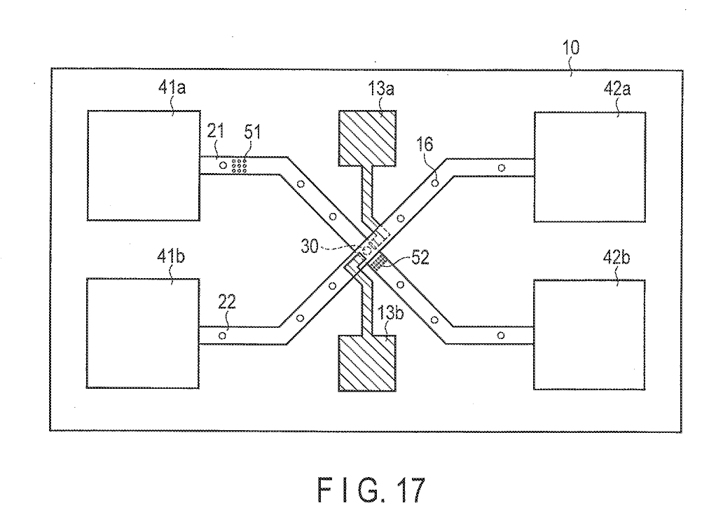

FIG. 17 is a plan view showing a brief structure of a sixth semiconductor micro-analysis chip. In this chip, a flow channel 21 and a flow channel 22 are formed in different steps, and a piled portion (contact portion) where the two flow channels intersect each other is provided. By this structure, double-decker flow channels in which the flow channel 21 serving as a sample supplying flow channel is formed at a lower side, and the flow channel 22 serving as a sample receiving flow channel is formed at an upper side are provided. Here, a micropore 30 is provided at the piled portion (contact portion) of the two flow channels. In other words, the micropore 30 is formed by photolithography at a partition (i.e., a cap layer 15 of the first flow channel 21) serving as an upper surface of the first flow channel 21 and a lower surface of the second flow channel 22.

In the semiconductor micro-analysis chip shown in FIGS. 10 to 16, the micropore 30 needs to be formed at the partition perpendicular to the silicon substrate 10 since two flow channels are laterally adjacent to each other with the partition sandwiched between them. For this reason, the slit-like micropore 30 is formed by patterning the partition from the side portions. At this time, the shape of the micropore is a rectangle close to a square when a depth of the flow channels is the same as a width of the micropore. Alternatively, the micropore is a vertically long slit when the depth of the flow channels is greater than the width of the micropore. For this reason, when particles pass through the micropore 30, the aperture of the micropore 30 cannot be sufficiently shielded by the particles, and thus a variation in an ion current is small in comparison with a circular micropore.

In contrast, in the analysis chip shown in FIG. 17, the micropore 30 can be directly patterned, and the aperture shape of the micropore can be arbitrarily determined. Thus, the micropore 30 can be designed to have a circular aperture by which the ion conduction can be most effectively shielded with the particles. At this time, the variation in the ion current associated with passing of the particles to be detected through the micropore 30 can be maximized, and the particles can be detected with much higher sensitivity than the detection by the semiconductor micro-analysis chip shown in FIGS. 10 to 16.

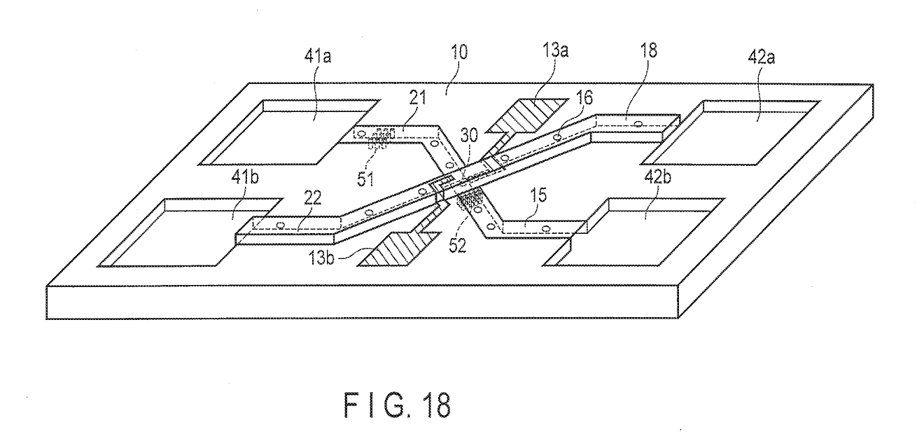

FIG. 18 illustrates a specific example of the double-decker flow channels. In this example, the first flow channel 21 is a tunnel flow channel of an Si substrate engraving type similar to the flow channel shown in FIG. 11 while the second flow channel 22 is a flow channel of an insulating film tunnel type similar to the flow channel shown in FIG. 16.

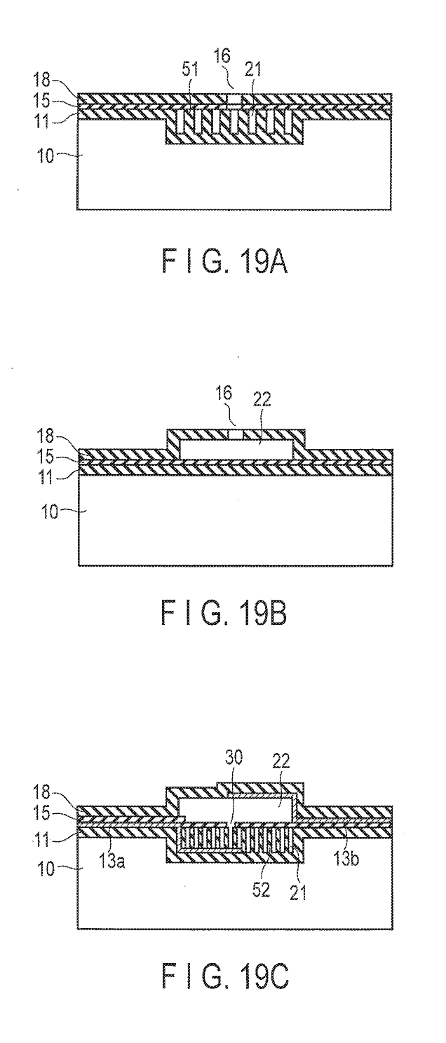

The first flow channel 21 is a tunnel flow channel of an engraving type as shown in FIG. 19A, and the second flow channel 22 is a flow channel of an insulating film tunnel type, that is, a flow channel made of an insulating film (a cap layer) 18, as shown in FIG. 19B.

In addition, the micropore 30 is formed in the insulating film 15 at the contact portion where the two flow channels 21 and 22 intersect each other, as shown in FIG. 19C, and an aperture shape of the micropore can be determined arbitrarily. The electrodes for observing the ion current are formed on a lower surface of the first flow channel 21 and an upper surface of the second flow channel 22, respectively. High sensitivity can be thereby realized by optimizing the shape of the micropore. In addition, the present semiconductor micro-analysis chip comprises the tunnel flow channel 21 of the Si engraving type, and the second flow channel 22 is formed on the insulating film 15. Therefore, the semiconductor micro-analysis chip also has an advantage that even if a gap is formed between an insulating film 11 and the insulating film 15 due to the residues of the sacrifice layer, no leakage current occurs between the two flow channels.

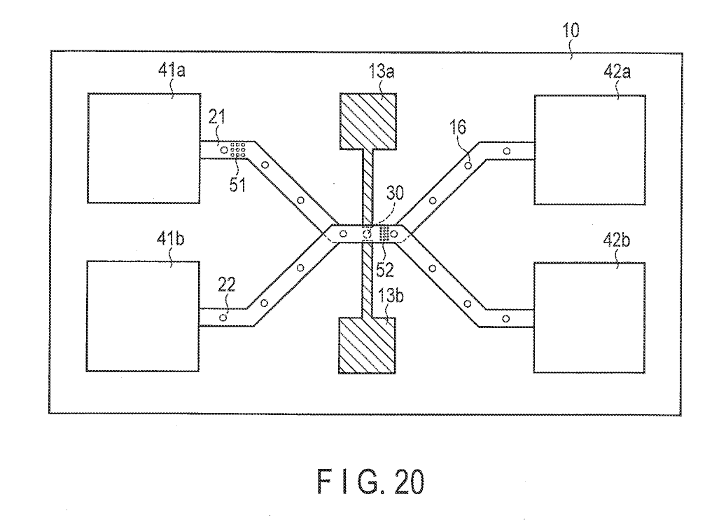

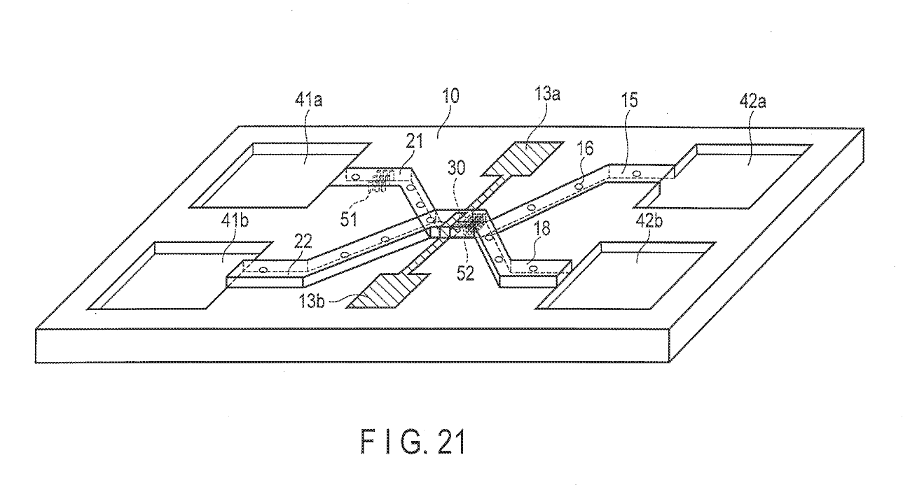

Since the two flow channels are arranged to intersect each other, a sample liquid introduced into an inlet 41a is to be discharged into an outlet 42b. However, the arrangement of the two flow channels is not limited to the intersection arrangement. For example, the two flow channels may be arranged as shown in the plan view of FIG. 20 or the perspective view of FIG. 21. In other words, the two flow channels may be arranged to be stacked and then to return to the respective corresponding flow channel sides (i.e., a sample liquid introduced into the inlet 41a may be discharged into the outlet 42a).

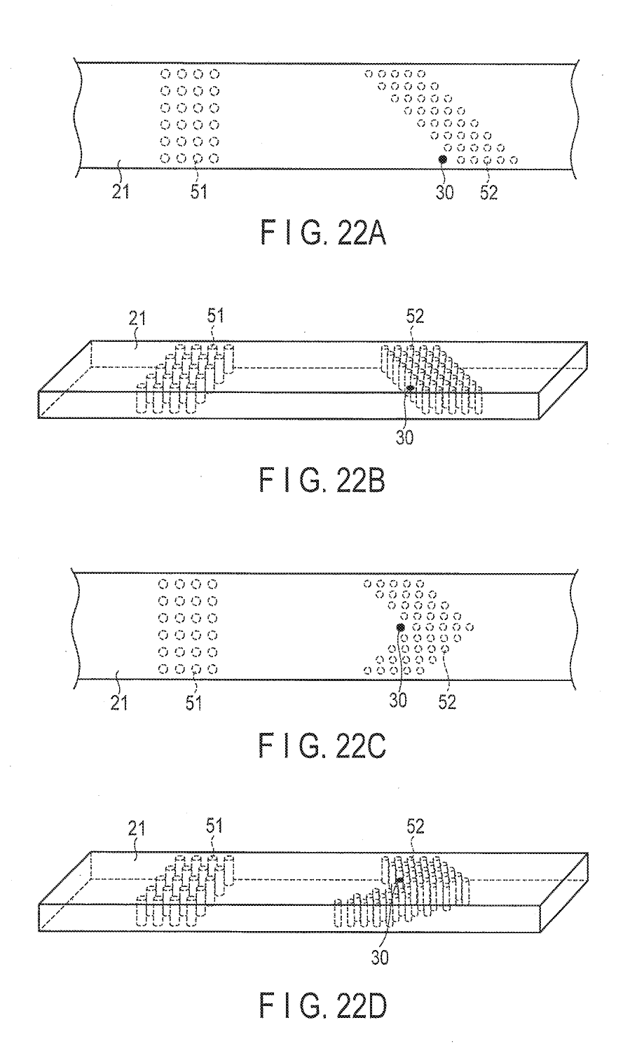

In FIGS. 22A and 22B, a pillar array 52 is arranged such that pillars of the pillar array 52 obliquely cross the flow channel 21, and the micropore 30 is positioned near a portion at the most downstream side of the upstream side ends of the pillars.

FIG. 22A is a plan view, and FIG. 22B is a perspective view. Thus, detection efficiency can be enhanced since the particles trapped by the pillar array 52 are efficiently guided to the micropore 30.

Further, in FIGS. 22C and 22D, pillars of the pillar array 52 are arranged in a form of “>” with respect to the flow channel direction. FIG. 22C is a plan view, and FIG. 22D is a perspective view. The same advantage as that of the arrangement shown in FIGS. 15A and 15B can be obtained by arranging the pillar array as such. Considering that the micropore 30 is formed in a predetermined size, the micropore 30 is positioned at a central portion of the flow channel 21, when the pillars are arranged in the form of “>”. Accordingly, the arrangement in the form “>” shown in FIGS. 22C and 22D can be formed more easily than the oblique arrangement shown in FIGS. 22A and 22B.

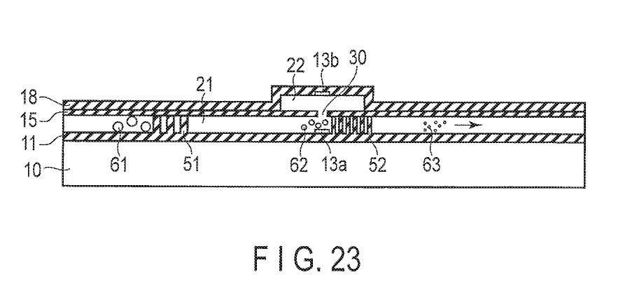

FIG. 23 schematically shows a particle detection mechanism. A function of the pillar arrays 51 and 52 is the same as that as shown in FIG. 14. In FIG. 23, by applying a voltage between the electrodes 13a and 13b, particles 62 collected by the pillar array 52 are electrophoresed between the electrodes 13a and 13b, and moved to the side of the flow channel 22 through the micropore 30. At this time, since the ion current flowing between the electrodes 13a and 13b varies, the particles 62 can be detected.

As can be seen, since the micropore 30 is formed to have the circular aperture by having the first flow channel 21 and the second flow channel 22 stacked, not only the same advantage as that of the third semiconductor micro-analysis chip can be obtained, but also the particles can be detected with higher sensitivity.

(Seventh Semiconductor Micro-Analysis Chip)

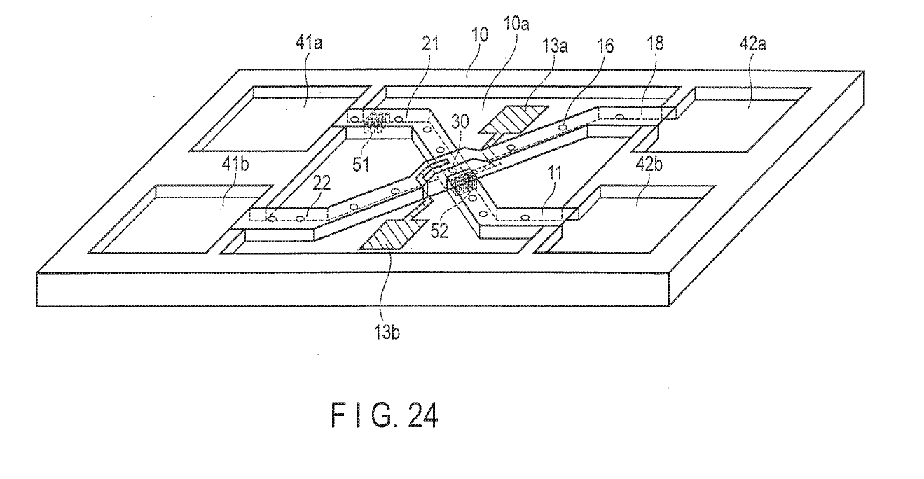

FIG. 24 is a perspective view showing a brief structure of a seventh semiconductor micro-analysis chip. This chip is a modified case in which a flow channel 21 and a flow channel 22 are formed in different steps, and a piled portion (contact portion) of the two flow channels is provided.

Both the first flow channel 21, which is a sample inlet flow channel, and the second flow channel 22, which is a sample receiving flow channel, are insulating film tunnel type flow channels. The two flow channels are formed in different steps, and a micropore 30 is formed by photolithography, at the piled portion of the two flow channels.

The inspection chip has a feature of solving inconvenience that filling the second flow channel with a sample liquid or an electrolyte sometimes cannot be successfully executed for the reason that the second flow channel 22 is different in height from a junction between the second flow channel 22 and the inlet/outlet (i.e., an opening portion) in the inspection chip in FIG. 23. In the present chip, the first flow channel 21 of an insulating film tunnel type is formed in a flow channel portion 10a formed on a substrate, and the second flow channel 22 of an insulating film tunnel type is formed similarly after the first flow channel 21 has been formed. Thereby, the first flow channel 21 and the second flow channel 22 can be substantially the same height at their reservoir portions (an inlet 41a and an inlet 41b).

At the piled portion (i.e., the contact portion in FIG. 24) of the two channels, a space of the second flow channel 22 can be secured as shown in FIG. 23, because in the process of forming the second flow channel, a sacrifice layer for the second flow channel automatically climbs over the first flow channel 21. In the case of filling the first flow channel 21 and the second flow channel 22 with the sample liquid (or electrolyte), a problem that filling failure occurs at either of the flow channels can be thereby solved.

Thus, the present chip has an advantage of being able to prevent failure in filling the flow channels with the sample liquid or the electrolyte, in addition to the advantage of the sixth semiconductor micro-analysis chip.

[Eighth Semiconductor Micro-Analysis Chip]

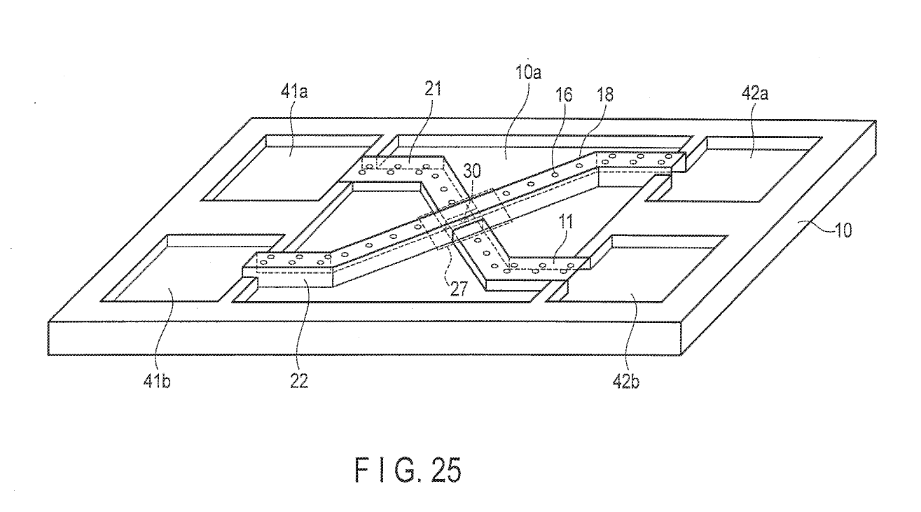

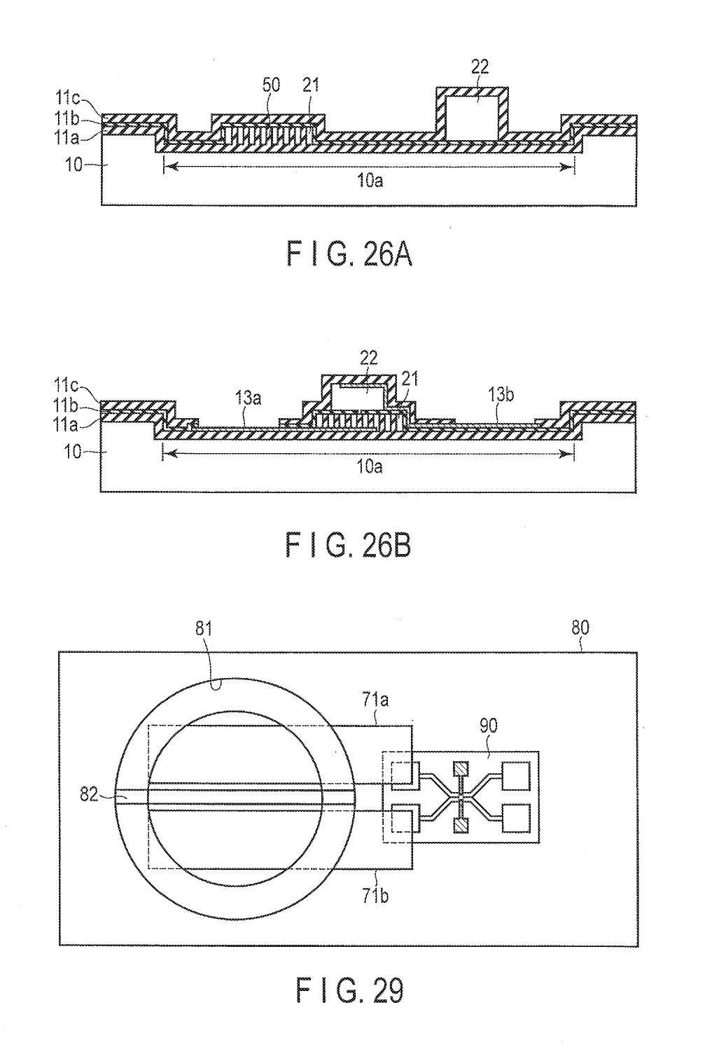

FIG. 25 is a perspective view showing a brief structure of an eighth semiconductor micro-analysis chip. This chip is a modified case in which a flow channel 21 and a flow channel 22 are formed in different steps, and a piled portion (contact portion) of the two channels is provided. FIG. 26A is a cross-sectional view of the flow channels, and FIG. 26B is a cross-sectional view of the contact portion of the flow channels.

Similarly to the inspection chip shown in FIG. 24, both the first flow channel 21, which is a sample inlet flow channel, and the second flow channel 22, which is a sample receiving flow channel, are insulating film tunnel type flow channels. The two flow channels are formed in different steps, and a micropore 30 is formed by photolithography at the piled portion of the two flow channels. Further, the second flow channel 22 is formed to be higher than the first flow channel 21, as shown in FIGS. 26A and 26B.

Space above the first flow channel, which works as the second flow channel 22, can be secured with certainty at the piled portion (contact portion of FIG. 25) of the flow channels 21 and 22. Thus, a problem that the second flow channel 22 is crushed at the piled portion of the flow channels 21 and 22, which may sometimes arise in the semiconductor micro-analysis chip shown in FIG. 24, can be resolved. In the inspection chip shown in FIG. 24, the second flow channel 22 is formed in the expectation that a second sacrifice layer would naturally climb over the first flow channel. However, because of product variations in the sacrifice layer materials and fluctuations of the temperature or moisture in the processing environment, it is difficult to form the flow channels with guaranteed reproducibility. In the semiconductor micro-analysis chip shown in FIG. 25, expecting an upper surface of the second flow channel to naturally climb over the first flow channel is not needed, because the flow channels which have different heights can be formed with certainty under different conditions for coating the sacrifice layer (i.e., spin speed, etc.) or using the sacrifice layer materials of different viscosity.

At this time, it is desirable that the first flow channel 21 and the second flow channel 22 are formed to have the same cross-sectional area to equalize the amounts of sample liquid (or electrolyte) filled into the flow channels 21 and 22, which causes a substantially equal capillary action in the flow channels 21 and 22. For example, in the case where the first flow channel 21 has a width of 50 μm and a height of 2 μm, and the second flow channel has a width of 20 μm and a height of 5 μm, the flow channels 21 and 22 have the same cross-sectional area and 3 μm-height space between the first flow channel and the second flow channel can be secured at the piled portion.

The present chip therefore has an advantage of being able to solve the problem of the piled portion of the flow channels 21 and 22 being crushed and to implement the micro-analysis chip of higher reliability, in addition to the advantage of the seventh semiconductor micro-analysis chip.

[Ninth Semiconductor Micro-Analysis Chip]

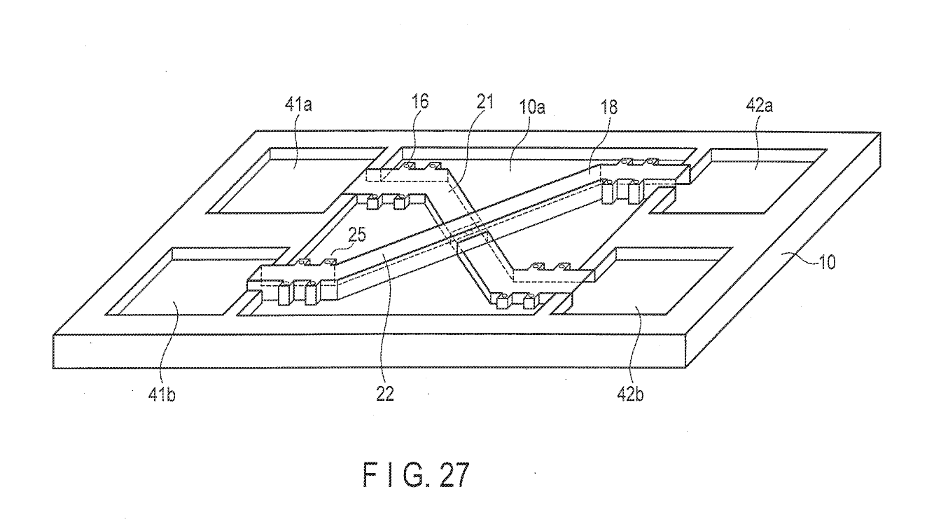

FIG. 27 is a perspective view showing a brief structure of a ninth semiconductor micro-analysis chip.

The basic structure of this chip is similar to that of the eighth semiconductor micro-analysis chip previously described. A difference between the present chip and the eighth semiconductor micro-analysis chip is that instead of providing ashing holes in flow channels, channel portions for forming ashing holes are provided on side walls of the flow channels and ashing holes are provided on these channels portions.

That is, at several portions of flow channels 21 and 22, channel portions 25 which are the same in height as the flow channels are provided on the side walls, and ashing holes 16 are formed on the upper surfaces of the channel portions 25. Further, pillar arrays which are not shown are formed in the flow channel 21.

With such a structure, in the process of removing a sacrifice layer for flow channel formation, oxygen plasma can be introduced into the flow channels 21 and 22 from ends of the flow channels 21 and 22 and the ashing holes 16 of the channel portions 25. Thereby, the sacrifice layer removal can be carried out speedily.

Thus, an advantage similar to that of the eighth semiconductor micro-analysis chip can be obtained.

Also, since the holes 16 are formed in the channel portions 25 provided on the side walls of the flow channels 21 and 22, instead of forming the holes directly in the flow channels 21 and 22, an advantage similar to that of the second semiconductor micro-analysis chip previously described can be obtained.

[Tenth Semiconductor Micro-Analysis Chip]

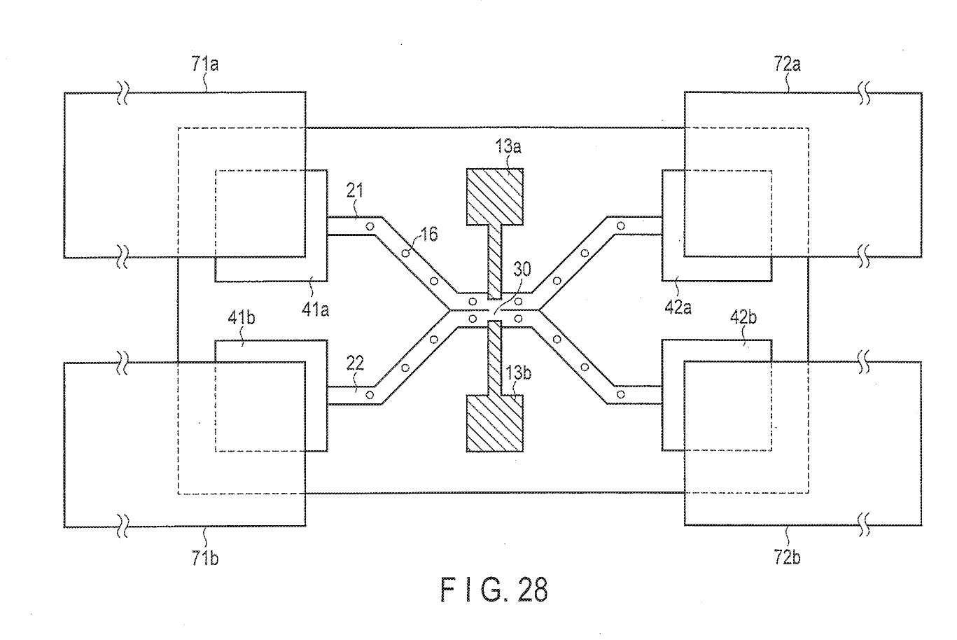

FIG. 28 is a plan view showing a brief structure of a tenth semiconductor micro-analysis chip. In the following description, a sample liquid is introduced into both a flow channel 21 and a flow channel 22, but an electrolyte may be introduced into either of the flow channels instead of the sample liquid.

An absorber 71a which can absorb the sample liquid is arranged on an inlet 41a, and an absorber 71b which can absorb the sample liquid or the electrolyte is arranged on an inlet 41b. Further, an absorber 72a which can absorb the sample liquid is arranged on an outlet 42a, and an absorber 72b which can absorb the sample liquid or the electrolyte is arranged on an outlet 42b. As the absorbers, filter paper and fiber assembly such as unwoven fabric can be used. Each of the absorbers may be arranged to cover all over a corresponding reservoir or arranged to partially cover the corresponding reservoir. However, the absorbers of adjacent reservoirs need to be separated from each other.

As described above in the third semiconductor micro-analysis chip, the sample liquid is supplied to the inlet 41a and either one of the sample liquid and the electrolyte may be supplied to the inlet 41b. An example of supplying the sample liquid to the inlet 41b will be hereinafter described.

In this structure, the sample liquids including particles to be detected dropped on the absorbers 71a and 71b seep from the absorbers 71a and 71b and are guided into the inlets 41a and 41b. The sample liquids guided into the inlets 41a and 41b reach the outlets 42a and 42b through the flow channels 21 and 22, respectively. The sample liquids flowing through the flow channels 21 and 22 are absorbed into the absorbers 72a and 72b arranged on the outlets 42a and 42b. Once the absorbers 72a and 72b start absorbing the sample liquids in the outlets 42a and 42b, sample liquids flowing into the outlets 42a and 42b in succession are absorbed into the absorbers 72a and 72b. Thus, the sample liquids in the flow channels 21 and 22 flow continuously.

That is, by absorbing the sample liquids using the absorbers 72a and 72b, the sample liquids in the flow channels 21 and 22 can be made to flow without using electrophoresis or an external pump, and particles included in the sample liquids can be made to move in the flow of the sample liquids. For this reason, the absorbers 71a and 71b on the sides of the inlets 41a and 41b can be omitted.

In addition, a sufficient amount of sample liquid can be supplied to the flow channels 21 and 22 without increasing the size of the semiconductor micro-analysis chip, by arranging the absorbers 71a and 71b on the sample liquid inlet side. In general, introduction of the sample liquid into a micro-analysis chip is executed by using a micropipet, etc., and the amount of instillation of the sample liquid is approximately 10 to 10,000 μl. To contain this amount of sample liquid, for example, an area of approximately 100 mm² is required with a depth of 100 μm. Integrating such a large containing region results in the manufacture of a semiconductor micro-analysis chip much larger than required for integrating a functional part of an analysis chip, considerably increasing manufacturing cost. In addition, concentration of the particles in the sample liquid is generally low. If it is necessary to detect a number of fine particles, a large amount of sample liquid needs to be introduced into the chip, and thus the sample liquid containing region needs to be vast.

In the tenth semiconductor micro-analysis chip, sufficiently large absorbers 71a and 71b are provided outside the analysis chip, instead of integrating a very large sample liquid containing region. Then, the sample liquids are instilled into the absorbers 71a and 71b and introduced into the flow channels 21 and 22, respectively. The sample liquids discharged from a sample outlet side can be absorbed into the absorbers 72a and 72b. Thus, a larger amount of sample liquid than the amount of the sample liquid contained in the analysis chip can be introduced and discharged.

It is desirable that pillar arrays with intervals greater than those of the above-mentioned particle size filter be formed in regions of the inlets and outlets 41a, 41b, 42a, and 42b, and that the absorbers be arranged to contact the pillar arrays. In this way, delivery of the sample liquid or the electrolyte between the absorbers 71a, 71b, 72a and 72b and the corresponding inlets and outlets is smoothly executed by a surface tension of the pillar arrays. Further, the sample liquid or the electrolyte can easily and smoothly be introduced into the flow channel from the absorber.

Thus, not only the advantage similar to that of the first semiconductor micro-analysis chip can be obtained, but also the advantage described below can be obtained as a result of providing the absorbers 71a, 71b, 72a, and 72b on the inlets and outlets 41a, 41b, 42a, and 42b.

That is, the sample liquids in the flow channels 21 and 22 can be made to flow without using electrophoresis or an external pump, by providing the absorbers 72a and 72b on the sides of the sample liquid outlets 42a and 42b. Further, a sufficient amount of sample liquid can be supplied to the flow channels 21 and 22 without increasing the size of the semiconductor micro-analysis chip, by providing the absorbers 71a and 71b on the sides of the sample liquid inlets 41a and 41b. A large amount of sample liquid can therefore be handled by a very small analysis chip. In other words, cost can be considerably reduced by integrating functional parts of the semiconductor micro-analysis chip in a minimum area.

[Eleventh Semiconductor Micro-Analysis Chip]

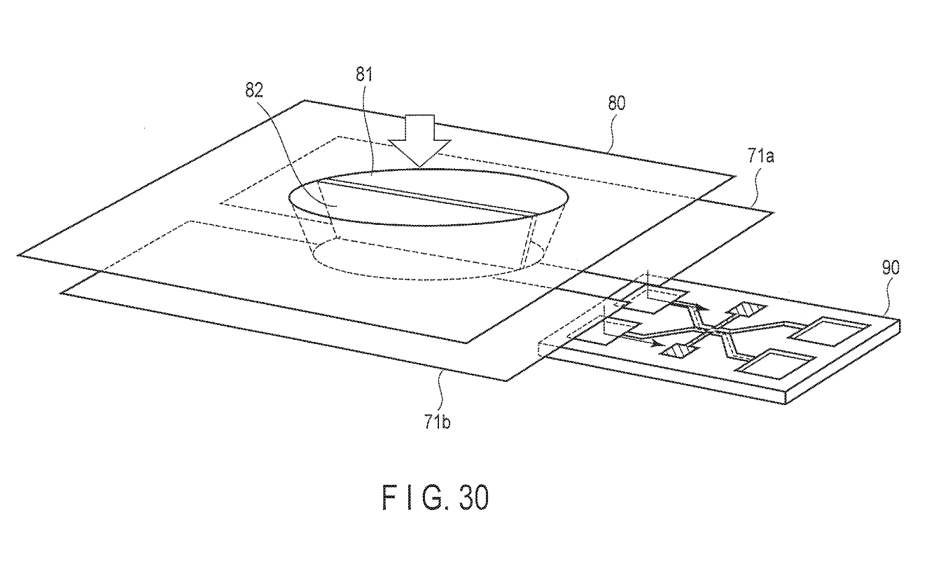

FIGS. 29 and 30 show a brief structure of an eleventh semiconductor micro-analysis chip 90. FIG. 29 is a plan view and FIG. 30 is a perspective view.

In the present semiconductor micro-analysis chip, a sample liquid inlet port 81 is provided on a package 80 configured to contain the semiconductor micro-analysis chip shown in FIG. 27. The sample liquid inlet port 81 is formed by forming an aperture on a top surface located above absorbers 71a and 71b of the package 80, and providing a funnel-shaped solution guide configured to guide a sample liquid to the absorbers 71a and 71b. The sample liquid inlet port 81 is great enough to spread over both the absorbers 71a and 71b. A partition plate 82 configured to separate the sample liquid for the absorber 71a and the absorber 71b is provided in the sample liquid inlet port 81.

FIG. 30 does not illustrate absorbers 72a and 72b on a sample liquid outlet side, but of course, the absorbers 72a and 72b may be provided. In addition, the structure of the semiconductor micro-analysis chip 90 is not limited to the example shown in FIG. 27, but can be arbitrarily modified similarly to the above-described examples.

In this structure, the sample liquid can be absorbed into the absorbers 71a and 71b with certain separation, only by dripping the sample liquid onto a central portion of the sample liquid inlet port 81. Then, the sample liquid can be guided to inlets 41a and 41b corresponding to the absorbers 71a and 71b, respectively, and can be made to further flow into flow channels 21 and 22. Therefore, the sample liquid does not need to be introduced to the inlets 41a and 41b individually, and can be guided by a simple operation. In addition, the size of the micro-analysis chip, in particular, the size of the reservoir portions can be minimized enough to overlap the absorbers, and the micro-analysis chip can be ultra-miniaturized. As a result, the cost of the micro-analysis chip can be reduced.

### Modified Embodiments

The particle inspection unit and the particle inspection system are not limited to the above-described embodiments.

In the embodiment, mainly the Si substrate is used as the inspection chip. However, the material of the substrate is not limited to Si, and other semiconductor substrate materials can be used as long as the semiconductor substrate can be processed in a general semiconductor manufacturing process. In addition, the insulating film is mainly expressed as a dielectric (SiO₂, SiNₓ, Al₂O₃), but a type, a composition, etc., of the film can be arbitrarily selected. Other than the above, an organic insulating film, for example, can also be used, and the insulating film is not limited to the disclosure of the embodiments. Further, the material of the cap layer, the size and the number of ashing holes provided at the cap layer, the places where the ashing holes should be arranged, etc., can arbitrarily be changed according to specifications.

Also, application of the particle inspection chip is not necessarily limited to the semiconductor micro-analysis chip, and the particle inspection chip may be applied to a product with a tunnel flow channel formed by providing a cover over a fine groove formed on a glass substrate or a resin substrate. Further, the memory element is not limited to a fuse or a semiconductor memory, and may be any element as long as it changes its state according to use of the inspection chip and enables detection of the use by a change in electrical signals from the control module side.

Further, in the above embodiments, cases of applying the inspection chip to inspection of viruses and bacteria have been described. However, the present embodiments are not limited to the above, and can be applied to inspection of various kinds of particles.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A particle inspection unit comprising:
a particle inspection chip comprising electrodes for detecting existence of particles in a sample liquid by a change in an electrical signal; and
a memory element which is provided separately from the electrodes and configured to electrically store whether the inspection chip has been used for inspection of the particles.

2. The unit of claim 1, wherein the inspection chip comprises a flow channel provided on a surface portion of a semiconductor substrate to allow the sample liquid to flow therein, and a micropore provided at a part of the flow channel to allow the particles in the sample liquid to pass therethrough.

3. The unit of claim 2, wherein the inspection chip further comprises a plurality of columnar structures which are spread over the inside of the flow channel, and extending from a bottom surface to an upper surface of the flow channel.

4. The unit of claim 2, further comprising a cap layer which covers an upper part of the flow channel, and a plurality of holes provided in the cap layer.

5. The unit of claim 2, wherein the flow channel is one of a groove-shaped tunnel-like flow channel formed by engraving the semiconductor substrate and providing an upper lid and a laminated tunnel-like flow channel formed by providing flow channel walls to form a hollow structure on the semiconductor substrate.

6. The unit of claim 1, wherein the inspection chip comprises:
a first flow channel provided on a surface portion of a semiconductor substrate to allow the sample liquid to flow therein;
a second flow channel provided on the surface portion of the semiconductor substrate, which is in a different layout from the first flow channel, to allow the sample liquid or an electrolyte to flow therein;
a contact portion where a part of the first flow channel and a part of the second flow channel are adjacent to each other or cross one another with a partition arranged between the flow channels;
a micropore provided in the partition to allow the particles to pass therethrough; and
electrodes provided in the first and second flow channels, respectively, with the micropore arranged therebetween.

7. The unit of claim 6, wherein
the first flow channel is a groove-shaped tunnel-like flow channel formed by engraving the semiconductor substrate and providing an upper lid, and the second flow channel is a laminated tunnel-like flow channel formed by providing flow channel walls to form a hollow structure on the semiconductor substrate, and
at least a part of the partition in the contact portion is an upper surface of the first flow channel and a bottom surface of the second flow channel.

8. The unit of claim 1, wherein the memory element is a fuse which is blown by electrical conduction when the inspection is conducted by the inspection chip.

9. The unit of claim 1, wherein the memory element comprises a fuse which is blown by electrical conduction, and a coloration material which changes its color by electrical conduction, when the inspection is conducted by the inspection chip.

10. A particle inspection system comprising:
an inspection module comprising a particle inspection chip comprising electrodes for detecting existence of particles in a sample liquid by a change in an electrical signal, and a memory element which is provided separately from the electrodes and configured to store whether the inspection chip is a used chip or not; and
a determination module comprising a determination circuit configured to determine the existence of the particles based on a detection signal of the inspection chip, and a control circuit configured to control an operation of the determination circuit from information in the memory element, wherein
the inspection chip and the determination circuit are electrically connected to each other, and the memory element and the control circuit are electrically connected to each other.

11. The system of claim 10, wherein the inspection module and the determination module are mechanically detachable, and electrical connection between the inspection module and the determination module is established as the inspection module is mounted in the determination module.

12. The system of claim 10, wherein the control circuit operates the determination circuit when the inspection chip is unused based on stored information of the memory element, and causes the memory element to store information that the inspection chip is used when determination is made by the determination circuit.

13. The system of claim 10, wherein the inspection chip comprises a flow channel provided on a surface portion of a semiconductor substrate to allow the sample liquid to flow therein, and a micropore provided at a part of the flow channel to allow the particles in the sample liquid to pass therethrough.

14. The system of claim 10, wherein the inspection chip comprises:
a first flow channel provided on a surface portion of a semiconductor substrate to allow the sample liquid to flow therein;
a second flow channel provided on the surface portion of the semiconductor substrate, which is in a different layout from the first flow channel, to allow the sample liquid or an electrolyte to flow therein;
a contact portion where a part of the first flow channel and a part of the second flow channel are adjacent to each other or cross one another with a partition arranged between the flow channels;
a micropore provided in the partition to allow the particles to pass therethrough; and
electrodes provided in the first and second flow channels, respectively, with the micropore arranged therebetween.

15. The system of claim 14, wherein the first flow channel is a groove-shaped tunnel-like flow channel formed by engraving the semiconductor substrate and providing an upper lid, and the second flow channel is a laminated tunnel-like flow channel formed by providing flow channel walls to form a hollow structure on the semiconductor substrate, and
at least a part of the partition in the contact portion is an upper surface of the first flow channel and a bottom surface of the second flow channel.

16. The system of claim 10, wherein the memory element is a fuse which is blown by electrical conduction from the control circuit when inspection is conducted by the inspection chip.

17. The system of claim 10, wherein the memory element comprises a fuse which is blown by electrical conduction from the control circuit, and a coloration material which changes its color by the electrical conduction from the control circuit, when inspection is conducted by the inspection chip.

18. The system of claim 11, further comprising a substrate on which the inspection module is mounted, and a housing which accommodates the determination module and is provided with a cassette insertion opening which allows the substrate to be inserted therein on a side surface of the housing, wherein
the inspection module and the determination module are electrically connected to each other as the substrate is inserted into the housing, and the inspection module and the determination module are electrically disconnected as the substrate is removed from the housing.

19. The system of claim 17, wherein
the substrate is configured to be partially broken as the substrate is removed from the housing, and is provided with an interconnect as the memory element at a portion to be broken, and
the interconnect is cut off as the substrate is removed from the housing.

20. A method of inspecting particles comprising:
employing the particle inspection system of claim 10;
reading information in the memory element by the control circuit with the inspection module mounted on the determination module;
operating the determination circuit by the control circuit when the inspection chip is unused;
inspecting existence of the particles based on the detection signal of the inspection chip by an operation of the determination circuit; and
storing information that the chip is used in the memory element by the control circuit upon completion of inspection by the determination circuit.
